(19) United States
(12) Patent Application Publication
(10) Pub. No.: US 2026/0058118 A1
(43) Pub. Date: Feb. 26, 2026

(54) POSITIVE ELECTRODE FOR ALL-SOLID-STATE BATTERY, ALL-SOLID-STATE BATTERY INCLUDING THE SAME, AND METHOD OF MANUFACTURING POSITIVE ELECTRODE FOR ALL-SOLID-STATE BATTERY

(71) Applicant: SAMSUNG SDI CO., LTD., Yongin-si (KR)

(72) Inventors: Jinhee KIM, Yongin-si (KR); Hoseon YOU, Yongin-si (KR); Dongwoo KANG, Yongin-si (KR); Daeyang OH, Yongin-si (KR)

(73) Assignee: SAMSUNG SDI CO., LTD., Yongin-si (KR)

(21) Appl. No.: 19/269,897

(22) Filed: Jul. 15, 2025

(30) Foreign Application Priority Data
Aug. 21, 2024 (KR) 10-2024-0111958

(51) Int. Cl. H01M 4/04

(52) U.S. Cl. CPC H01M 4/0435; H01M 4/0404

(57) ABSTRACT

Disclosed is a method of manufacturing a positive electrode. The method comprises manufacturing a first electrode plate by forming a first positive electrode active material layer on a first substrate, manufacturing a second electrode plate by forming a second positive electrode active material layer on a second substrate, stacking the second electrode plate on the first electrode plate to allow the second positive electrode active material layer to face the first positive electrode active material layer, laminating the first electrode plate and the second electrode plate, and recovering the second substrate. A first elongation of the first substrate is greater than a second elongation of the second substrate.

### CROSS-REFERENCE TO RELATED APPLICATION

This application claims priority under 35 U.S.C § 119 to Korean Patent Application No. 10-2024-0111958 filed on Aug. 21, 2024 in the Korean Intellectual Property Office, the disclosure of which is hereby incorporated by reference in its entirety.

### BACKGROUND

The present disclosure relates to a positive electrode for an all-solid-state battery, an all-solid-state battery including the positive electrode, and a method of manufacturing the positive electrode.

There is an increase in the development of high-energy density and safe batteries driven by industrial demands. For example, lithium ion batteries are commercialized not only in formation-related and communication devices, but also in the automotive industry. In the automotive industry, safety is emphasized due to a direct relation thereof to preserving human lives.

An all-solid-state battery may use a solid electrolyte in place of a liquid electrolyte. As all-solid-state batteries do not use flammable organic dispersion mediums, the possibility of fire or explosion may be significantly reduced even in the event of short-circuits.

### SUMMARY

Some example embodiments of the present disclosure include an all-solid-state battery with improved stability and desired or improved electrochemical characteristics.

According to some example embodiments of the present disclosure, a method of manufacturing a positive electrode may include manufacturing a first electrode plate by forming a first positive electrode active material layer on a first substrate, manufacturing a second electrode plate by forming a second positive electrode active material layer on a second substrate, stacking the second electrode plate on the first electrode plate to allow the second positive electrode active material layer to face the first positive electrode active material layer, laminating the first electrode plate and the second electrode plate, and recovering the second substrate. A first elongation of the first substrate may be greater than a second elongation of the second substrate.

According to some example embodiments of the present disclosure, a method of manufacturing a positive electrode may include preparing a first slurry that includes a first positive electrode active material, a first solid electrolyte, a first conductive material, and a first binder; preparing a second slurry that includes a second positive electrode active material, a second solid electrolyte, a second conductive material, and a second binder; coating on a first substrate the first slurry to form a first positive electrode active material layer; coating on a second substrate the second slurry to form a second positive electrode active material layer; stacking the second positive electrode active material layer on the first positive electrode active material layer, the second positive electrode active material layer being on the second substrate; laminating the first positive electrode active material layer and the second positive electrode active material layer; and recovering the second substrate. A first elongation of the first substrate may be greater than a second elongation of the second substrate.

### BRIEF DESCRIPTION OF DRAWINGS

FIG. 1 illustrates a plan view showing an all-solid-state battery, according to some example embodiments of the present disclosure.

FIG. 2 illustrates a cross-sectional view taken along line A-A′ of FIG. 1.

FIG. 3 illustrates a cross-sectional view taken along line A-A′ of FIG. 1, showing an all-solid-state battery, according to some example embodiments of the present disclosure.

FIG. 4 illustrates a cross-sectional view showing a positive electrode, according to some example embodiments of the present disclosure.

FIG. 5 illustrates a flow chart showing a method of manufacturing a positive electrode, according to some example embodiments of the present disclosure.

FIGS. 6 to 9 illustrate cross-sectional views showing a method of manufacturing a first electrode plate, according to some example embodiments of the present disclosure.

FIG. 6 illustrates a conceptual diagram showing a method of manufacturing a first electrode plate.

FIG. 7 illustrates a cross-sectional view showing a first slurry coating process.

FIG. 8 illustrates a cross-sectional view showing a first slitting process.

FIG. 9 illustrates a cross-sectional view showing a first electrode plate.

FIGS. 10 to 13 illustrate cross-sectional views showing a method of manufacturing a second electrode plate, according to some example embodiments of the present disclosure.

FIG. 10 illustrates a conceptual diagram showing a method of manufacturing a first electrode plate.

FIG. 11 illustrates a cross-sectional view showing a first slurry coating process.

FIG. 12 illustrates a cross-sectional view showing a first slitting process.

FIG. 13 illustrates a cross-sectional view showing a first electrode plate.

FIGS. 14 to 16 illustrate cross-sectional views showing a method of manufacturing a positive electrode according to some embodiments of the present disclosure.

FIG. 14 illustrates a conceptual diagram showing a method of manufacturing a positive electrode.

FIG. 15 illustrates a cross-sectional view showing a lamination process.

FIG. 16 illustrates a cross-sectional view showing a second substrate recovery process.

FIGS. 17 and 18 illustrate images capturing an embodiment and a comparative example of the present disclosure.

### DETAILED DESCRIPTION OF EMBODIMENTS

In order to sufficiently understand the configuration and effect of the present disclosure, some example embodiments of the present disclosure are described with reference to the accompanying drawings. It should be noted, however, that the present disclosure is not limited to the following example embodiments, and may be implemented in various forms. Rather, the example embodiments are provided only to disclose the present disclosure and let those skilled in the art fully know the scope of the present disclosure.

In this disclosure, it is understood that, when an element is referred to as being “on” another element, the element can be “directly on” the other element, or intervening elements may be present therebetween. In the drawings, thicknesses of some components are exaggerated for effectively explaining the technical contents. Like reference numerals refer to like elements throughout the specification.

Unless otherwise specially noted in this description, the expression of singular form may include the expression of plural form. In addition, unless otherwise specially noted, the phrase “A or B” may indicate “A but not B,” “B but not A,” and “and B.” The terms “comprises/includes” and/or “comprising/including” used in this description do not exclude the presence or addition of one or more other components.

In this description, the term “combination thereof” may refer to a mixture, a stack, a composite, a copolymer, an alloy, a blend, or a reaction product.

In this description, the term “metal” may include metals or metalloids, such as silicon and germanium, in an elemental or ionic state.

In this description, the term “alloy” may refer to a mixture of two or more metals.

In this description, the term “positive electrode active material” may refer to a positive electrode material capable of undergoing lithiation and delithiation.

In this description, the term “negative electrode active material” may refer to a negative electrode material capable of undergoing lithiation and delithiation.

In this description, the terms “lithiation” and “to lithiate” may refer to a process of adding lithium to a positive electrode active material or a negative electrode active material.

In this description, the terms “delithiation” and “to delithiate” may refer to a process of removing lithium from a positive electrode active material or a negative electrode active material.

In this description, the terms “charge” and “to charge” may refer to a process of providing electrochemical energy to a battery.

In this description, the terms “discharge” and “to discharge” may refer to a process of removing electrochemical energy from a battery.

In this description, the term “positive electrode” may refer to an electrode in which electrochemical reduction and lithiation occur during a discharge process.

In this description, the term “negative electrode” may refer to an electrode in which electrochemical oxidation and delithiation occur during a discharge process.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

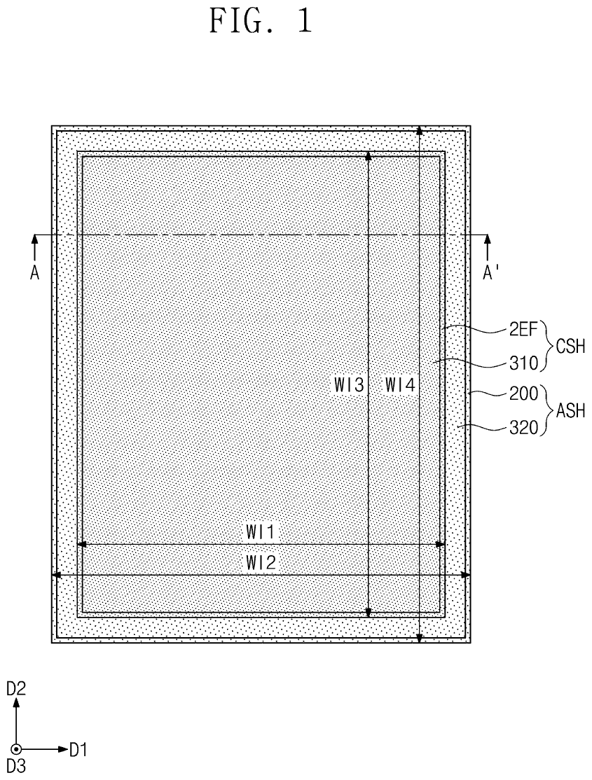

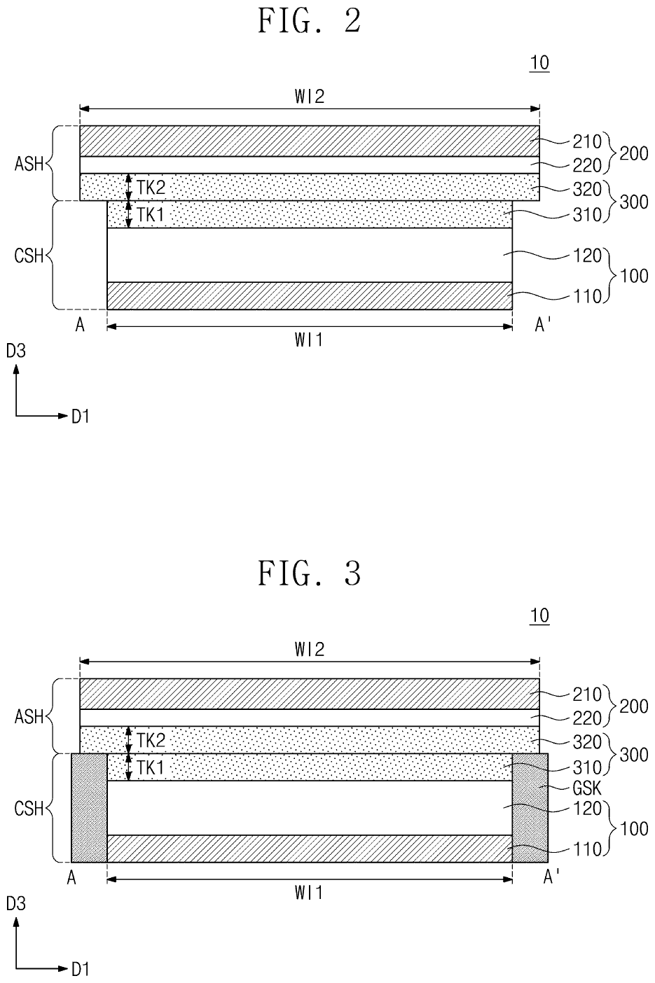

FIG. 1 illustrates a plan view illustrating an all-solid-state battery according to some example embodiments of the present disclosure. FIG. 2 illustrates a cross-sectional view taken along line A-A′ of FIG. 1.

Referring to FIGS. 1 and 2, an all-solid-state battery 10 according to examples of the present disclosure may include a positive electrode layer 100, a negative electrode layer 200 opposite to the positive electrode layer 100, and a solid electrolyte layer 300 disposed between the positive electrode layer 100 and the negative electrode layer 200. The present disclosure, however, is not limited thereto, and the all-solid-state battery 10 may further include an additional functional layer, such as, e.g., an adhesion enhancement layer, disposed between the positive electrode layer 100 and the solid electrolyte layer 300 or between the negative electrode layer 200 and the solid electrolyte layer 300.

The positive electrode layer 100 according to an example embodiment of the present disclosure may include a positive electrode current collector 110 and a positive electrode active material layer 120 disposed on the positive electrode current collector 110. The positive electrode active material layer 120 may include at least one of a positive electrode active material, a solid electrolyte, a conductive material, and a binder.

The positive electrode current collector 110 may provide a reference surface on which the positive electrode active material layer 120 is disposed. For example, the positive electrode current collector 110 may include a plate or foil including at least one of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof.

Differently from the structure illustrated in FIG. 2, in an example embodiment of the present disclosure, the positive electrode current collector 110 may be omitted. Although not shown, in order to increase adhesion between the positive electrode current collector 110 and the positive electrode active material layer 120, a carbon layer of about 0.1 μm to about 4 μm in thickness may further be disposed between the positive electrode current collector 110 and the positive electrode active material layer 120.

The positive electrode active material of the positive electrode active material layer 120 may include a material that can reversibly absorb and desorb lithium ions. The positive electrode active material may include a plurality of particles. The positive electrode active material may include, for example, at least one of lithium transition metal oxide (e.g., lithium cobalt oxide (LCO), lithium nickel oxide, lithium nickel cobalt oxide, lithium nickel cobalt aluminum oxide (NCA), lithium nickel cobalt manganese oxide (NCM), lithium manganate, or lithium iron phosphate), nickel sulfide, copper sulfide, lithium sulfide, iron oxide, or vanadium oxide, but the present disclosure is not limited thereto. The positive electrode active material may be included alone or in a mixture of two or more substances.

The lithium transition metal oxide may be or include, for example, a compound represented by one of LiₐA_{1-b}B_{b}D₂ (where 0.90≤a≤1 and 0≤b≤0.5), LiₐE_{1-b}B_{b}O_{2-c}D_{c} (where 0.90≤a≤1, 0≤b≤0.5, and 0≤c≤0.05), LiE_{2-b}B_{b}O_{4-c}D_{c} (where 0≤b≤0.5 and 0≤c≤0.05), LiₐNi_{1-b-c}Co_{b}B_{c}D_{α} (where 0.90≤a≤1, 0≤b≤0.5, 0≤c≤0.05, and 0<α<2), LiₐNi_{1-b-c}Co_{b}B_{c}O_{2-α}F_{α} (where 0.90≤a≤1, 0≤b≤0.5, 0≤c≤0.05, and 0<α<2), LiₐNi_{1-b-c}Mn_{b}B_{c}D_{α} (where 0.90≤a≤1, 0≤b≤0.5, 0≤c≤0.05, and 0<α≤2), LiₐNi_{1-b-c}Mn_{b}B_{c}O_{2-α}F_{α} (where 0.90≤a≤1, 0≤b≤0.5, 0≤c≤0.05, and 0<α<2), LiₐNi_{b}E_{c}G_{d}O₂ (where 0.90≤a≤1, 0≤b≤0.9, 0≤c≤0.5, and 0.001≤d≤0.1), LiₐNi_{b}Co_{c}Mn_{d}GₑO₂ (where 0.90≤a≤1, 0≤b≤0.9, 0≤c≤0.5, 0≤d≤0.5, and 0.001≤e≤0.1), LiₐNiG_{b}O₂ (where 0.9≤a≤1 and 0.001≤b≤0.1), LiₐCoG_{b}O₂ (where 0.90≤a≤1 and 0.001≤b≤0.1), LiₐMnG_{b}O₂ (where 0.90≤a≤1 and 0.001≤b≤0.1), LiₐMn₂G_{b}O₄ (where 0.90≤a≤1 and 0.001≤b≤0.1), QO₂, QS₂, LiQS₂, V₂O₅, LiV₂O₅, LiIO₂, LiNiVO₄, Li_{3-f}J₂(PO₄)₃ (where 0≤f≤2), Li_{3-f}Fe₂(PO₄)₃ (where 0≤f≤2), LiFePO_{4.}

In the compounds above, “A” may be or include at least one of Ni, Co, Mn, or a combination thereof, “B” may be or include at least one of Al, Ni, Co, Mn, Cr, Fe, Mg, Sr, V, a rare-earth element, or a combination thereof, “D” may be or include at least one of O, F, S, P, or a combination thereof, “E” may be or include at least one of Co, Mn, or a combination thereof, “F” may be or include at least one of F, S, P, or a combination thereof, “G” may be or include at least one of Al, Cr, Mn, Fe, Mg, La, Ce, Sr, V, or a combination thereof, “Q” may be or include at least one of Ti, Mo, Mn, or a combination thereof, “I” may be or include at least one of Cr, V, Fe, Sc, Y, or a combination thereof, and “J” may be or include at least one of V, Cr, Mn, Co, Ni, Cu, or a combination thereof.

The positive electrode active material may include, for example, a lithium salt of transition metal oxide having a layered rock salt type structure among lithium transition metal oxides discussed above. The term “layered rock salt type structure” may refer to a structure in which an oxygen atom layer and a metal atom layer are alternately and regularly arranged in a <111> direction of a cubic rock salt type structure, where each atom layer forms a two-dimensional plane. The term “cubic rock salt type structure” may refer to a sodium chloride (NaCl) type structure, which is a type of crystal structure, and for example, has a structure in which face centered cubic lattices (FCCs) each formed of cations and anions are arranged displaced from each other by ½ of a ridge of a unit lattice. The lithium transition metal oxide having the layered rock salt type structure may be or include a ternary lithium transition metal oxide, such as LiNiₓCo_{y}Al_{z}O₂ (NCA) or LiNiₓCo_{y}Mn_{z}O₂ (NCM) (where 0<x<1, 0<y<1, 0<z<1, and x+y+z=1). When the positive electrode active material includes a ternary lithium transition metal oxide having the layered rock salt type structure, the all-solid-state battery 10 may improve in energy density and thermal stability.

The compound included in the positive electrode active material may be covered with a coating layer (not shown). The positive electrode active material may be included in a mixture of the compound and a compound to which the coating layer is added. The coating layer added to a surface of the positive electrode active material may include, for example, at least one of oxide, hydroxide, oxyhydroxide, oxycarbonate, or hydrocarbonate of a coating element discussed below. The compound of the coating layer may be or include amorphous or crystalline. The coating element included in the coating layer may include at least one of Mg, Al, Co, K, Na, Ca, Si, Ti, V, Sn, Ge, Ga, B, As, Zr, or a mixture thereof. The coating layer may include, for example, Li₂O—ZrO₂ (LZO). A method for forming the coating layer may be any one of methods that do not adversely affect physical characteristics of the positive electrode active material. For example, spray coating or immersion may be utilized to form the coating layer.

When the positive electrode active material includes nickel (Ni) as a ternary lithium transition metal oxide such as NCA or NCM, a capacity density of the all-solid-state battery 10 may increase to reduce metal elution of the positive electrode active material in a charged state. Thus, the all-solid-state battery 10 may improve in cycle characteristics in a charged state. The language “cycle characteristics” may refer to properties that indicate the degree to which the all-solid-state battery 10 is degraded due to charge and discharge. For example, the all-solid-state battery 10 with high cycle characteristics may degrade less due to charge and discharge, while the all-solid-state battery 10 with low cycle characteristics may degrade more due to charge and discharge.

The positive electrode active material may have a substantially spherical or substantially oval particle shape. There is no limitation on a particle diameter and an amount of the positive electrode active material.

The solid electrolyte of the positive electrode active material layer 120 may have a particle shape. The solid electrolyte may be dispersed between the positive electrode active materials. The solid electrolyte may include a sulfide-based solid electrolyte with desired or improved lithium ion conductivity. The sulfide-based solid electrolyte may include, for example, at least one of Li₂S—P₂S₅, Li₂S—P₂S₅—LiX (where X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each a positive integer, and “Z” is one of Ge, Zn, and Ga), Li₂S—GeS₂, Li₂S—SiS2—Li₃PO₄, Li₂S—SiS₂—LiₚMO_{q} (where p and q are each a positive integer, and “M” is one of P, Si, Ge, B, Al, Ga, and In), Li₇₋ₓPS₆₋ₓClₓ (where 0≤x≤2), Li₇₋ₓPS₆₋ₓBrₓ (where 0≤x≤2), and Li₇₋ₓPS₆₋ₓIₓ (where 0≤x≤2).

The sulfide-based solid electrolyte may be or include an argyrodite-type compound including, for example, at least one of Li₇₋ₓPS₆₋ₓClₓ (where 0≤x≤2), Li₇₋ₓPS₆₋ₓBrₓ (where 0≤x≤2), and Li₇₋ₓPS₆₋ₓIₓ (where 0≤x≤2). For example, the sulfide-based solid electrolyte may be or include an argyrodite-type compound including at least one of Li₆PS₅Cl, Li₆PS₅Br, and Li₆PS₅I.

Alternatively, the sulfide-based solid electrolyte may be or include an argyrodite-type compound including Li₇₋ₐMₐPS_{6-c}X_{c} (where 0≤a≤2 and 0≤c≤2). In the chemical formula above, X may be or include at least one of F, Br, Cl, or a combination thereof. In addition, M may be or include at least one of scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), zinc (Zn), cadmium (Cd), mercury (Hg), aluminum (Al), gallium (Ga), indium (In), thallium (Tl), silicon (Si), germanium (Ge), tin (Sn), lead (Pb), arsenic (As), antimony (Sb), bismuth (Bi), or a combination thereof.

The argyrodite-type solid electrolyte may have a density in a range of about 1.5 g/cc to about 2.0 g/cc. As the argyrodite-type solid electrolyte has a density that is equal to or greater than about 1.5 g/cc, it may be possible to decrease an internal resistance of an all-solid-state battery, and to hinder or prevent a solid electrolyte layer from short-circuit and penetration caused by the formation of lithium dendrite. The solid electrolyte may have an elastic modulus in a range of, for example, about 15 GPa to about 35 GPa.

The solid electrolyte in the positive electrode active material layer 120 may have an average particle diameter that is less than the average particle diameter of a solid electrolyte in the solid electrolyte layer 300 which is discussed below. For example, the average particle diameter of the solid electrolyte in the positive electrode active material layer 120 may be equal to or less than about 90%, equal to or less than about 80%, equal to or less than about 70%, equal to or less than about 60%, equal to or less than about 50%, equal to or less than about 40%, equal to or less than about 30%, or equal to or less than about 20% of the average particle diameter of the solid electrolyte in the solid electrolyte layer 300. The average particle diameter may be a median diameter measured by a laser particle size distribution analyzer.

The positive electrode active material layer 120 may include a conductive material. The conductive material may have conductivity without causing chemical change of the all-solid-state battery 10 to increase conductivity of the positive electrode active material and the solid electrolyte. The conductive material may include a carbon-based material. The conductive material may include, for example, one or more of graphite, carbon black, acetylene black, carbon nano-fiber, and carbon nano-tube.

The positive electrode active material layer 120 may further include a binder. The binder may combine the positive electrode active material, the solid electrolyte, and the conductive material to each other in the positive electrode active material layer 120. The binder may include a material for improving adhesion between the positive electrode active material layer 120 and the positive electrode current collector 110. The binder may include, for example, one or more of polyvinylidenefluoride, styrene butadiene rubber (SBR), polytetrafluoroethylene, vinylidenefluoride/hexafluoropropylene copolymers, polyacrylonitrile, and polymethyl methacrylate.

Based on the total 100 parts by weight of the positive electrode active material, the solid electrolyte, the conductive material, and the binder, the positive electrode active material may be included in an amount in a range of about 80 parts by weight to about 92 parts by weight in the positive electrode active material layer 120. Based on the total 100 parts by weight of the positive electrode active material, the solid electrolyte, the conductive material, and the binder, the binder may be included in an amount in a range of about 0.5 parts by weight to about 1.5 parts by weight in the positive electrode active material layer 120.

Based on 100 parts by weight of the solid electrolyte, the conductive material may be included in an amount in a range of about 1 part by weight to about 50 parts by weight in the positive electrode active material layer 120. When the positive electrode active material layer 120 includes the conductive material in an amount that is less than about 1 part by weight based on 100 parts by weight of the solid electrolyte, a proportion of the conductive material may decrease to reduce electrical conductivity of the positive electrode active material layer 120. When the positive electrode active material layer 120 includes the conductive material in an amount that is greater than about 50 parts by weight based on 100 parts by weight of the solid electrolyte, a proportion of the conductive material may excessively increase to cause incomplete formation of a coating layer that covers a surface of the solid electrolyte.

The positive electrode active material layer 120 may further include an additive, such as a filler, a coating agent, a dispersant, and an ion conductivity agent, in addition to the positive electrode active material, the solid electrolyte, the conductive material, and the binder.

With reference to FIGS. 1 and 2, the negative electrode layer 200 may include a negative electrode current collector 210 and a negative electrode coating layer 220 on the negative electrode current collector 210. The negative electrode current collector 210 may provide a reference surface on which the negative electrode coating layer 220 is formed. The negative electrode current collector 210 may include a material that does not react, or does not substantially react, with lithium, for example, a material that does not form an alloy or a compound with lithium. For example, the negative electrode current collector 210 may include at least one metal such as or including copper (Cu), stainless steel, titanium (Ti), iron (Fe), cobalt (Co), and nickel (Ni). A thickness of the negative electrode current collector 210 may range from about 1 μm to about 20 μm, for example, from about 5 μm to about 15 μm or from about 7 μm to about 10 μm.

The negative electrode current collector 210 may be formed of or include one of the metals mentioned above, an alloy of two or more of the metals mentioned above, or a coating material. The negative electrode current collector 210 may have, for example, a substantially plate shape or a foil shape. In an example embodiment, the negative electrode current collector 210 may be omitted.

The negative electrode coating layer 220 may induce growth of lithium metal between the negative electrode coating layer 220 and the negative electrode current collector 210 when the all-solid-state battery 10 is charged. The negative electrode coating layer 220 may be configured as a protection layer for lithium metal, and may simultaneously or contemporaneously reduce or suppress precipitation and growth of lithium dendrite.

The negative electrode coating layer 220 may include metal and carbon. For example, the negative electrode coating layer 220 may include at least one of gold (Au), platinum (Pt), palladium (Pd), silicon (Si), silver (Ag), aluminum (Al), bismuth (Bi), tin (Sn), and zinc (Zn). The negative electrode coating layer 220 may include at least one of carbon black, acetylene black, furnace black, Ketjen black, and graphene. In an example embodiment, the negative electrode coating layer 220 may include a mixture of carbon black and silver (Ag).

The negative electrode coating layer 220 may further include an additive in addition to metal and carbon. The negative electrode coating layer 220 may include at least one additive including, for example, at least one of a binder, a filler, a coating agent, a dispersant, and an ion conductivity agent.

The binder included in the negative electrode coating layer 220 may include at least one of styrene-butadiene rubber (SBR), polytetrafluoroethylene, polyvinylidene fluoride (PVDF), polyethylene, vinylidenefluoride/hexafluoropropylene copolymer, polyacrylonitrile, and polymethyl methacrylate.

The binder may be included in an amount in a range of about 1 part by weight to about 30 parts by weight relative to 100 parts by weight of the negative electrode coating layer 220. For example, the binder may be included in an amount in a range of about 5 parts by weight to about 15 parts by weight relative to 100 parts by weight of the negative electrode coating layer 220.

Although not shown, a carbon layer may further be included to increase adhesion between the negative electrode coating layer 220 and the solid electrolyte layer 300.

With reference to FIGS. 1 and 2, the solid electrolyte layer 300 may be provided between the positive electrode layer 100 and the negative electrode layer 200. The solid electrolyte layer 300 may include a sulfide-based solid electrolyte with desired or improved lithium ion conductivity. The solid electrolyte in the solid electrolyte layer 300 may include a material that is the same as, or different from, one of the materials included in the solid electrolyte in the positive electrode active material layer 120.

The solid electrolyte layer 300 may include a first solid electrolyte layer 310 and a second solid electrolyte layer 320. The first solid electrolyte layer 310 may be adjacent to the positive electrode layer 100, and the second solid electrolyte layer 320 may be adjacent to the negative electrode layer 200.

Referring to FIG. 2, the first solid electrolyte layer 310 may include a first solid electrolyte. The first solid electrolyte may have a substantially spherical or substantially oval particle shape. The first solid electrolyte may include a sulfide-based solid electrolyte. The first solid electrolyte may be amorphous, crystalline, or in a mixed state of amorphous and crystalline. The solid electrolyte may include at least sulfur (S), phosphorus (P), and lithium (Li) among component elements included in the sulfide-based solid electrolyte mentioned above. For example, the solid electrolyte may be or include a material including Li₂S—P₂S₅. When a material including Li₂S—P₂S₅ is utilized as a sulfide-based solid electrolyte material of the solid electrolyte, a mixing molar ratio of Li₂S and P₂S₅ may be in a range of about 50:50 to about 90:10.

In an example embodiment, the sulfide-based solid electrolyte may be or include an argyrodite-type compound including at least one of Li₇₋ₓPS₆₋ₓClₓ (where 0≤x≤2), Li₇₋ₓPS₆₋ₓBrₓ (where 0≤x≤2), and Li₇₋ₓPS₆₋ₓIₓ (where 0≤x≤2). The first solid electrolyte may be or include an argyrodite-type compound including at least one of Li₆PS₅Cl, Li₆PS₅Br, and Li₆PS₅I.

In an example embodiment, the first solid electrolyte may include an argyrodite-type compound including Li₇₋ₐMₐPS_{6-c}X_{c}. In the chemical formula above, X may be or include at least one of Cl, Br, or a combination thereof. M may be or include at least one of Na, K, Fe, Mg, Ca, Ag, Cu, Zr, Zn, or a combination thereof. The subscripts a and c may each be a real number in a range between 0 and 2.

The argyrodite-type solid electrolyte may have a density in a range of about 1.5 g/cc to about 2.0 g/cc. As the argyrodite-type solid electrolyte has a density that is equal to or greater than about 1.5 g/cc, it may be possible to decrease an internal resistance of an all-solid-state battery, and to hinder or prevent a solid electrolyte layer from short-circuit and penetration caused by the formation of lithium dendrite. The first solid electrolyte may have an elastic modulus in a range of, for example, about 15 GPa to about 35 GPa.

The first solid electrolyte layer 310 may further include a binder. The binder included in the first solid electrolyte layer 310 may include at least one of styrene-butadiene rubber (SBR), polytetrafluoroethylene, polyvinylidenefluoride, and polyethylene, but the present disclosure is not limited thereto. The binder of the first solid electrolyte layer 310 may be the same as, or similar to, the binder of the positive electrode active material layer 120 or the binder of the negative electrode coating layer 220.

The second solid electrolyte layer 320 may include a second solid electrolyte. The second solid electrolyte may have a substantially spherical or substantially oval particle shape.

The second solid electrolyte may include a sulfide-based solid electrolyte. A description of the second solid electrolyte may be the same as or similar to the description of the first solid electrolyte. In an example embodiment, the second solid electrolyte may have a composition that is substantially the same as the composition of the first solid electrolyte. Alternatively, the second solid electrolyte may have a composition that is similar to the composition of the first solid electrolyte.

The second solid electrolyte may be in direct contact with the negative electrode coating layer 220. Thus, the second solid electrolyte may reduce or suppress the formation of lithium dendrites between the negative electrode coating layer 220 and the negative electrode current collector 210. The second solid electrolyte may effectively hinder or suppress a negative electrode side reaction. Accordingly, the all-solid-state battery 10 according to examples of the present disclosure may improve in cell performance.

The first solid electrolyte layer 310 may have a first thickness TK1, and the second solid electrolyte layer 320 may have a second thickness TK2. The first thickness TK1 and the second thickness TK2 may be the same as or different from each other. In an example embodiment, the first thickness TK1 may be greater than the second thickness TK2. For example, the first thickness TK1 may be about 1.1 times to about 10 times the second thickness TK2.

Referring back to FIGS. 1 and 2, the positive electrode layer 100 and the first solid electrolyte layer 310 may constitute a positive electrode mixture layer CSH. The negative electrode layer 200 and the second solid electrolyte layer 320 may constitute a negative electrode mixture layer ASH. The positive electrode mixture layer CSH may be stacked on the negative electrode mixture layer ASH.

The negative electrode mixture layer ASH and the positive electrode mixture layer CSH may have different areas from each other. For example, the area of the negative electrode mixture layer ASH may be greater than the area of the positive electrode mixture layer CSH. The positive electrode mixture layer CSH may substantially completely overlap within the negative electrode mixture layer ASH.

In an example embodiment of the present disclosure, the first solid electrolyte layer 310 may have substantially the same area as the positive electrode layer 100. The second solid electrolyte layer 320 may have substantially the same area as the negative electrode layer 200.

For example, with reference to FIG. 1, the positive electrode mixture layer CSH may have a first width WI1 in a first direction D1. The negative electrode mixture layer ASH may have a second width WI2 in the first direction D1. The first width WI1 may be less than the second width WI2. The positive electrode mixture layer CSH may have a third width WI3 in a second direction D2. The negative electrode mixture layer ASH may have a fourth width WI4 in the second direction D2. The third width WI3 may be less than the fourth width WI4.

The all-solid-state battery 10 according to the present example embodiment may be fabricated by forming the negative electrode mixture layer ASH on a first carrier film, forming the positive electrode mixture layer CSH on a second carrier film, and then laminating the negative electrode mixture layer ASH and the positive electrode mixture layer CSH.

FIG. 3 illustrates a cross-sectional view taken along line A-A′ of FIG. 1, illustrating an all-solid-state battery according to some example embodiments of the present disclosure. In the example embodiment that follows, a detailed description of technical features that are redundant to the features discussed above with reference to FIGS. 1 and 2 is omitted, and a difference thereof is discussed in detail.

Referring to FIG. 3, the all-solid-state battery 10 according to examples of the present disclosure may further include a gasket GSK. The gasket GSK may be configured to surround the positive electrode mixture layer CSH. The gasket GSK may fill a step difference on a lateral surface of the all-solid-state battery 10, the step difference being formed due to a difference in area between the negative electrode mixture layer ASH and the positive electrode mixture layer CSH. The gasket GSK may surround four lateral surfaces of the positive electrode mixture layer CSH. For example, a thickness of the gasket GSK may be substantially the same as the thickness of the positive electrode mixture layer CSH.

A top surface of the second solid electrolyte layer 320 may include a first region in contact with the first solid electrolyte layer 310 and a second region in contact with the gasket GSK. The second region may be a section around the top surface of the second solid electrolyte layer 320. The second region may surround the first region.

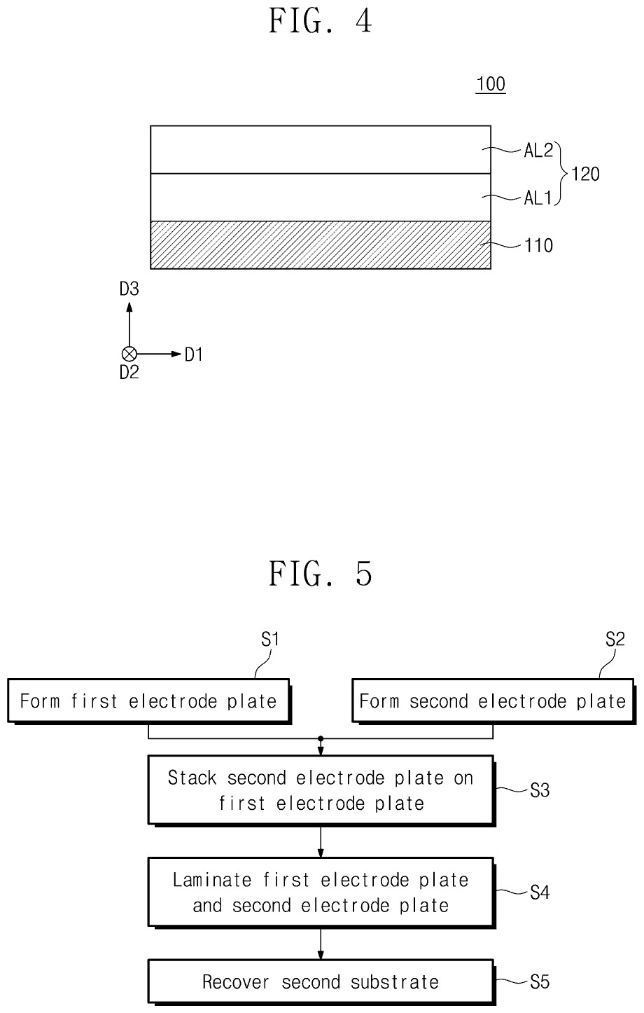

FIG. 4 illustrates a cross-sectional view showing a positive electrode according to some example embodiments of the present disclosure. The same features as the features of the all-solid-state battery discussed above with reference to FIGS. 1 to 3 may be omitted for brevity of description.

Referring to FIG. 4, Referring to FIG. 4, a first positive electrode active material layer AL1 may be disposed on the positive electrode current collector 110, and a second positive electrode active material layer AL2 may be disposed on the first positive electrode active material layer AL1

The first positive electrode active material layer AL1 may include at least one of a first positive electrode active material, a first solid electrolyte, a first binder, and a first conductive material. The second positive electrode active material layer AL2 may include at least one of a second positive electrode active material, a second solid electrolyte, a second binder, and a second conductive material.

The positive electrode current collector 110 may correspond to the positive electrode current collector 110 discussed above with reference to FIGS. 1 to 3. The first positive electrode active material, the first solid electrolyte, the first binder, and the first conductive material may respectively correspond to the positive electrode active material, the solid electrolyte, the binder, and the conductive material discussed above with reference to FIGS. 1 to 3. The second positive electrode active material, the second solid electrolyte, the second binder, and the second conductive material may respectively correspond to the positive electrode active material, the solid electrolyte, the binder, and the conductive material discussed above with reference to FIGS. 1 to 3.

The first positive electrode active material layer AL1 and the second positive electrode active material layer AL2 may have material compositions that are different from each other. For example, an amount of the first solid electrolyte in the first positive electrode active material layer AL1 may be greater than the amount of the second solid electrolyte in the second positive electrode active material layer AL2. For example, the amount of the first solid electrolyte in the first positive electrode active material layer AL1 may range from about 15 wt % to about 22 wt %, and the amount of the second solid electrolyte in the second positive electrode active material layer AL2 may range from about 10 wt % to about 14 wt %. As the first solid electrolyte in the first positive electrode active material layer AL1 adjacent to the positive electrode current collector 110 has a large amount, a positive electrode may have increased ionic conductivity.

For example, an amount of the first binder in the first positive electrode active material layer AL1 may be less than the amount of the second binder in the second positive electrode active material layer AL2. For example, the amount of the first binder in the first positive electrode active material layer AL1 may range from about 0.5 wt % to about 0.85 wt %, and the amount of the second binder in the second positive electrode active material layer AL2 may range from about 0.9 wt % to about 1.5 wt %. As the second binder in the second positive electrode active material layer AL2 spaced apart from the positive electrode current collector 110 has a large amount, a positive electrode may have improved stability.

The positive electrode active material layer 120 may have a loading level that is equal to or greater than about 35 mg/cm², for example, in a range of about 30 mg/cm² to about 50 mg/cm². In this description, the term “loading level” may refer to an amount of an active material per unit area of an electrode, and may be a factor designed in consideration of a diffusion coefficient of lithium ions, conduction between particles, and a path to a current collector.

In a positive electrode for an all-solid-state battery according to an example embodiment, based on the positive electrode active material layer 120 positioned on one side of the positive electrode current collector 110, positive electrode active material particles may have a loading level that is equal to or greater than about 35 mg/cm², for example, equal to or greater than about 40 mg/cm² or equal to or greater than about 45 mg/cm². When the positive electrode active material layers 120 are coated on opposite sides of the positive electrode current collector 110, positive electrode active materials may have a loading level that is equal to or greater than about 70 mg/cm², equal to or greater than about 80 mg/cm², or equal to or greater than about 90 mg/cm².

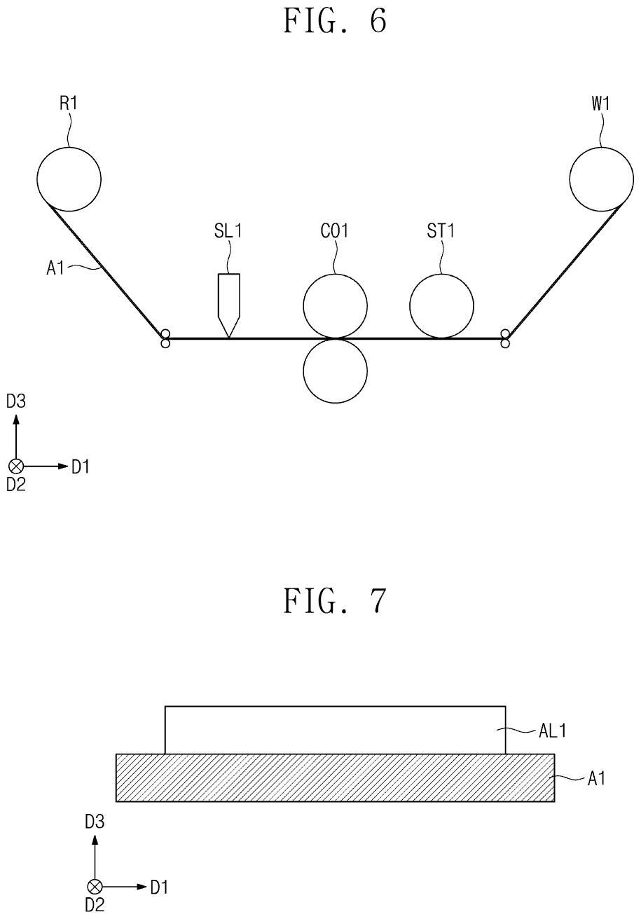

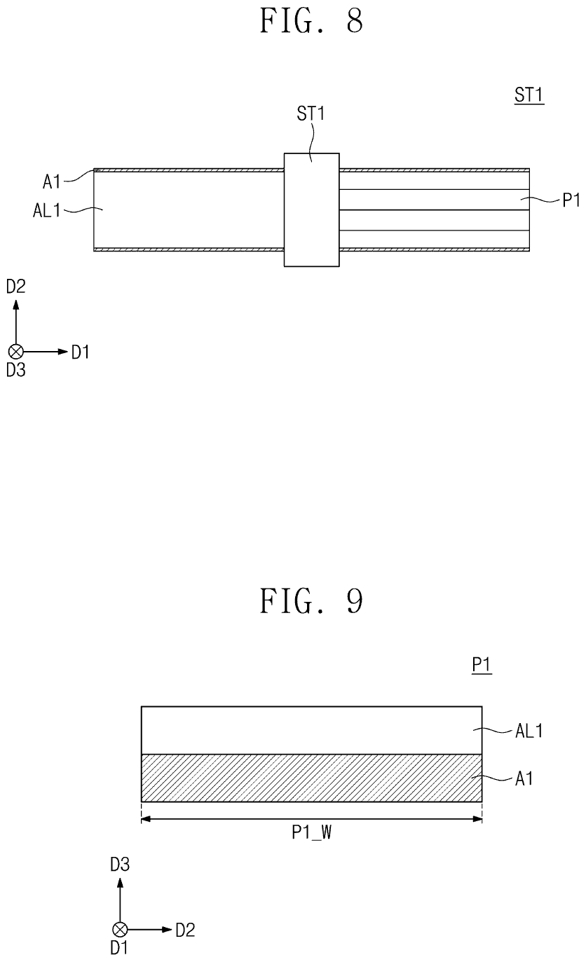

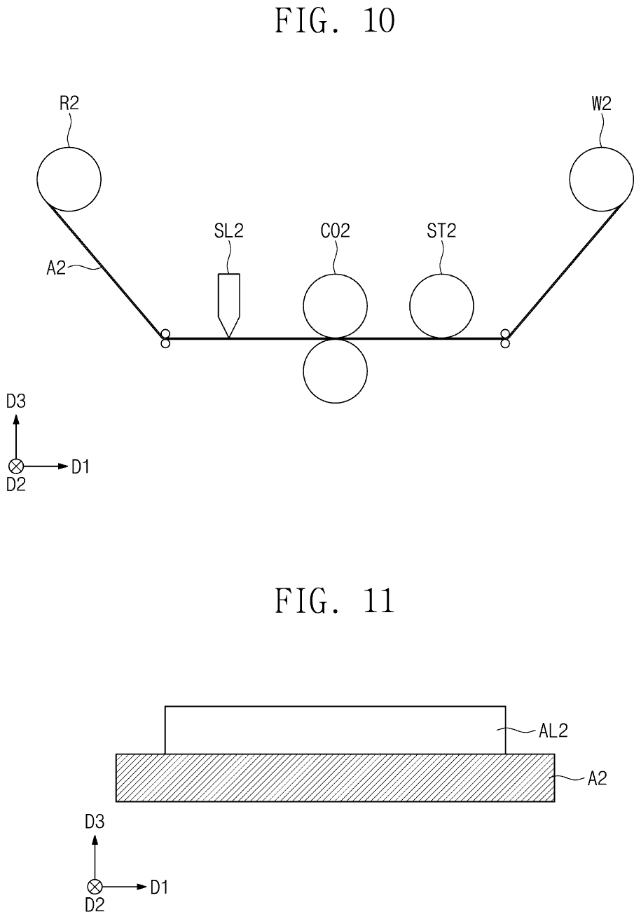

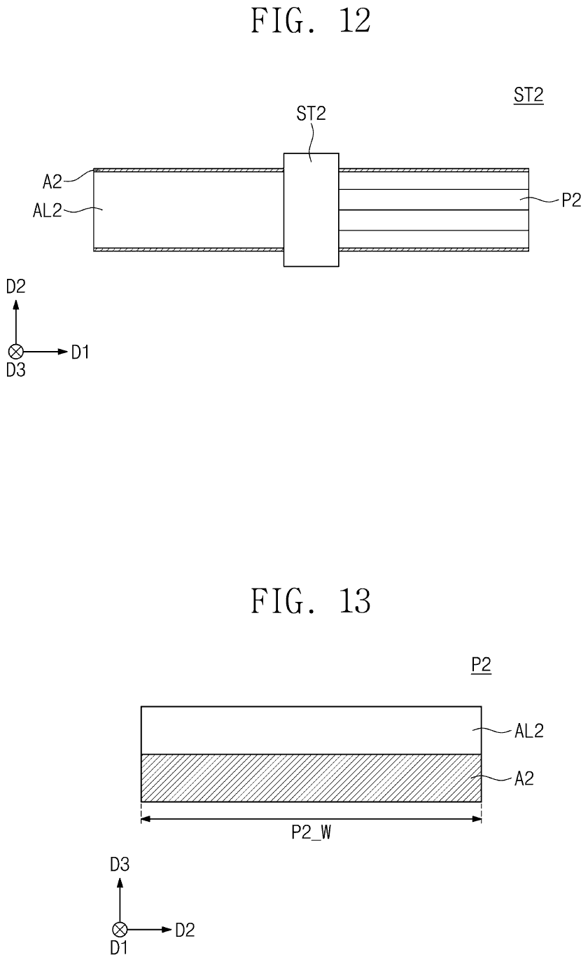

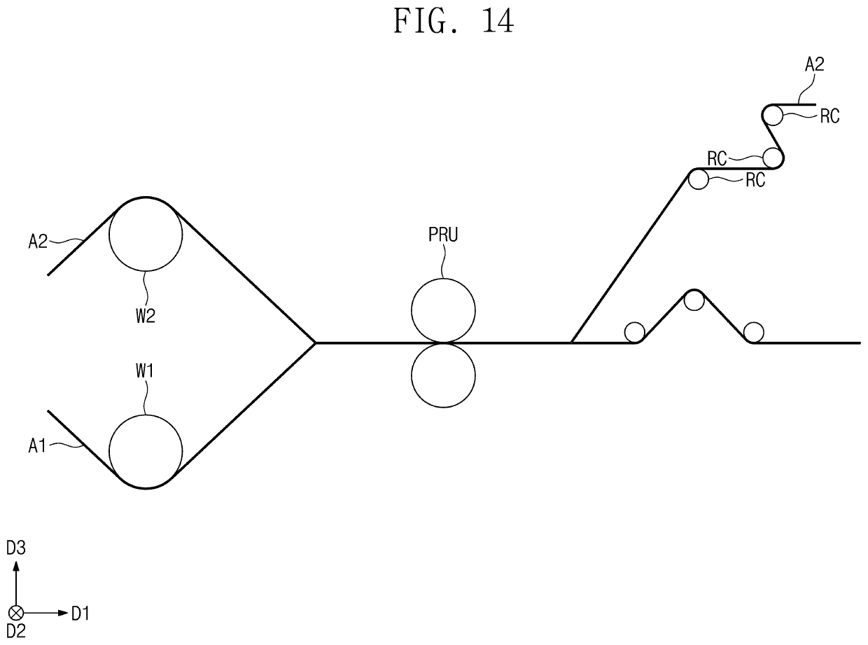

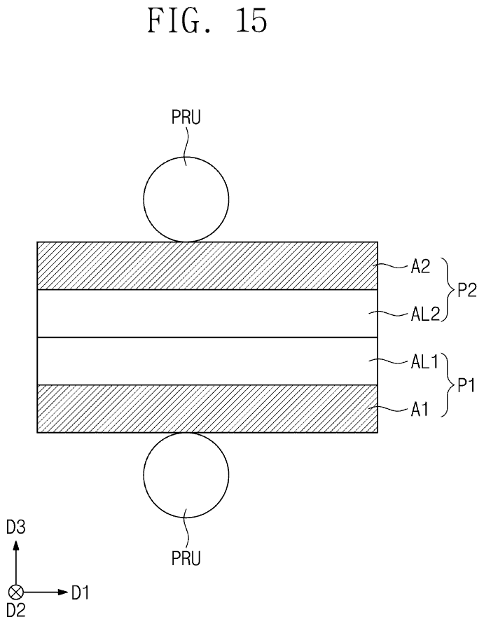

FIG. 5 illustrates a flow chart showing a method of manufacturing a positive electrode, according to some example embodiments of the present disclosure. FIGS. 6 to 9 illustrate cross-sectional views showing a method of manufacturing a first electrode plate according to some example embodiments of the present disclosure. FIG. 6 illustrates a conceptual diagram showing a method of manufacturing a first electrode plate. FIG. 7 illustrates a cross-sectional view showing a first slurry coating process. FIG. 8 illustrates a cross-sectional view showing a first slitting process. FIG. 9 illustrates a cross-sectional view showing a first electrode plate. FIGS. 10 to 13 illustrate cross-sectional views showing a method of manufacturing a second electrode plate according to some example embodiments of the present disclosure. FIGS. 14 to 16 illustrate cross-sectional views showing a method of manufacturing a positive electrode according to some example embodiments of the present disclosure. The same features as the features of the all-solid-state battery discussed with reference to FIGS. 1 to 3 may be omitted for brevity of description.

Referring to FIG. 5, a method of manufacturing a positive electrode may include manufacturing or forming a first electrode plate (S1), manufacturing or forming a second electrode plate (S2), stacking the second electrode plate on the first electrode plate (S3), laminating the first electrode plate and the second electrode plate (S4), and recovering a second substrate (S5).

Manufacturing the first electrode plate (S1) may include preparing a first slurry, coating the first slurry on a first substrate, and cutting the first substrate along a first direction.

The first slurry may include a first positive electrode active material, a first solid electrolyte, a first binder, and a first conductive material. A description of the first positive electrode active material, the first solid electrolyte, the first binder, and the first conductive material may be the same as discussed above with reference to FIGS. 1 to 4.

Referring to FIGS. 6 and 7, a wound first substrate A1 may be unwound from a first supply roll R1. The first substrate A1 may move along a first direction D1. The first substrate A1 may have a first elongation in a range of, for example, about 8% to about 10%. The first substrate A1 may include at least one of indium (In), aluminum (Al), lithium (Li), and an alloy thereof. The first substrate A1 may correspond to the positive electrode current collector 110 of FIGS. 1 to 4.

A first slurry supply SL1 may substantially uniformly supply the first slurry on the first substrate A1, and a first coater CO1 may coat the first slurry on the first substrate A1. In the coating process, the first slurry may be dried or solidified at a temperature in a range of, for example, about 140° C. to about 170° C. The coating process may include pressing the first slurry.

The coating process may form a first positive electrode active material layer AL1 on the first substrate A1.

Referring to FIGS. 6, 8, and 9, a first slitter ST1 may cut the first substrate A1 along the first direction D1. The first slitter ST1 may divide the first substrate A1 into a plurality of first substrates A1 having substantially the same width (for example, a width in a second direction D2). A plurality of first electrode plates P1 may thus be manufactured. The plurality of first electrode plates P1 may have substantially the same width P1_W in the second direction D2. Referring back to FIG. 6, the plurality of first electrode plates P1 may be wound around and received in a first winding roll W1.

For example, the manufacture of the second electrode plate (S2) may include preparing a second slurry, coating the second slurry on a second substrate, and cutting the second substrate along a first direction. The second slurry may include a second positive electrode active material, a second solid electrolyte, a second binder, and a second conductive material.

An amount of the second solid electrolyte in the second slurry may be less than the amount of the first solid electrolyte in the first slurry. An amount of the second binder in the second slurry may be greater than the amount of the first binder in the first slurry. A description of the second positive electrode active material, the second solid electrolyte, the second binder, and the second conductive material may be the same as discussed above with reference to FIGS. 1 to 4.

Referring to FIGS. 10 and 11, a second supply roll R2 may force a second substrate A2 to move along the first direction D1. The second substrate A2 may have a second elongation that is less than the first elongation of the first substrate A1. For example, the first elongation may be about 1.14 times to about 8.3 times the second elongation. The second elongation may be, for example, in a range of about 1.2% to about 7%. The second substrate A2 may include, for example, at least one of copper (Cu), magnesium (Mg), titanium (Ti), iron (Fe), cobalt (Co), nickel (Ni), zinc (Zn), stainless steel, germanium (Ge), and an alloy thereof.

A second slurry supply SL2 may substantially uniformly supply the second slurry on the second substrate A2, and a second coater CO2 may coat the second slurry on the second substrate A2. In the coating process, the second slurry may be dried or solidified at a temperature in a range of, for example, about 140° C. to about 170° C. The coating process may include pressing the second slurry. The coating process may form a second positive electrode active material layer AL2 on the second substrate A2.

Referring to FIGS. 10, 12, and 13, a second slitter ST2 may cut the second substrate A2 in the first direction D1. The second slitter ST2 may divide the second substrate A2 into a plurality of second substrates A2 having substantially the same width (for example, a width in the second direction D2). A plurality of second electrode plates P2 may thus be manufactured. The plurality of second electrode plates P2 may have substantially the same width P2_W in the second direction D2. The width P1_W in the second direction D2 of the first electrode plate P1 may be substantially the same as the width P2_W in the second direction D2 of the second electrode plate P2.

Referring back to FIG. 10, the plurality of second electrode plates P2 may be wound around and received in a second winding roll W2.

Referring to FIGS. 14 and 15, the second electrode plate P2 may be placed on the first electrode plate P1. For example, the first electrode plate P1 may be provided from the first winding roll W1, and the second electrode plate P2 may be provided from the second winding roll W2. The second positive electrode active material layer AL2 of the second electrode plate P2 may be provided to face the first positive electrode active material layer AL1 of the first electrode plate P1. Afterwards, the second electrode plate P2 may be stacked on the first electrode plate P1. After the second electrode plate P2 is stacked on the first electrode plate P1, the first electrode plate P1 and the second electrode plate P2 may be laminated to each other.

The lamination may be performed in, e.g., a roll-to-roll process. The lamination may be executed by, for example, a pressing unit PRU. The pressing unit PRU may include a pressing roller. The pressing unit PRU may roll-press the first electrode plate P1 and the second electrode plate P2.

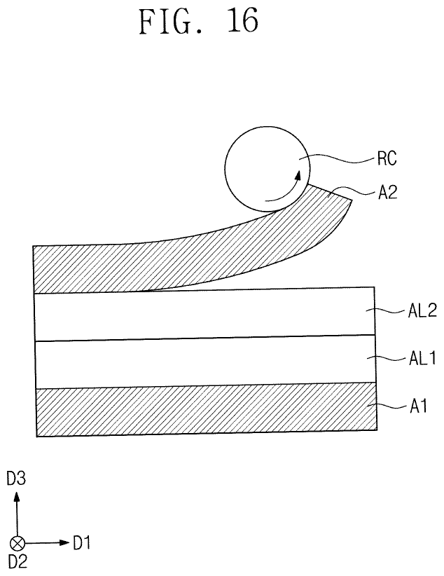

Referring to FIGS. 14 and 16, the second substrate A2 may be recovered. The recovery of the second substrate A2 may include, for example, allowing a recovery roll RC to recover the second substrate A2. In this step, as the second elongation of the second substrate A2 has a low value, the second substrate A2 may be readily recovered. Thus, the second substrate A2 may be removed without leaving residues on the second positive electrode active material layer AL2.

Thereby, the anode for an all-solid-state battery according to example embodiments of the present disclosure may be formed. Through the lamination process the first anode active material layer AL1 and the second anode active material layer AL2 may form a unity. The first anode active material layer AL1 and the second anode active material layer AL2 may be referred to as the anode active material layer 120 The anode for an all-solid-state battery according to example embodiments of the present disclosure may have a loading level of anode active material particles in a range of 35 mg/cm² or more, such as 40 mg/cm² or more, or 45 mg/cm² or more, based on the anode active material layer 120 located on a first surface of the first base material A1. When the anode active material layers 120 are coated on both sides of the first base material A1, the loading level of the anode active material particles may be in a range of 70 mg/cm² or more, 80 mg/cm² or more, or 90 mg/cm² or more.

According to some example embodiments of the present disclosure, the second substrate A2 may be removed without leaving residues on the second positive electrode active material layer AL2. Accordingly, a thick layer may improve in quality.

Herein, examples of the present disclosure are described in detail with reference to some example embodiments. The following example embodiments are provided for illustrative purpose only, and are not to be construed to limit the scope of the present disclosure.

### Embodiment

### Manufacture of Positive Electrode

A powder of LiNi_{0.8}Co_{0.15}Mn_{0.05}O₂ (NCM) was prepared as a first positive electrode active material. A crystalline argyrodite-type solid electrolyte was prepared as a first solid electrolyte, polyvinylidenefluoride (PVDF) was prepared as a first binder, and carbon nano-fiber (CNF) was prepared as a first conductive material. The first positive electrode active material, the first solid electrolyte, the first conductive material, and the first binder were mixed in a weight ratio of about 83:15:0.5:1 in an anisole solvent to prepare a first slurry. The first slurry was coated on an aluminum positive electrode current collector as a first substrate, and then dried to manufacture a first electrode plate.

A powder of LiNi_{0.8}Co_{0.15}Mn_{0.05}O₂ (NCM) was prepared as a second positive electrode active material. A crystalline argyrodite-type solid electrolyte (Li₆PS₅Cl) was prepared as a second solid electrolyte, polyvinylidenefluoride (PVDF) was prepared as a second binder, and carbon nano-fiber (CNF) was prepared as a second conductive material. The second positive electrode active material, the second solid electrolyte, the second conductive material, and the second binder were mixed in a weight ratio of 83:15:0.5:1 in an anisole solvent to prepare a second slurry. The second slurry was coated on a copper substrate as a second substrate, and then dried to manufacture a second electrode plate.

The second electrode plate was stacked on the first electrode plate, and then a pressing process was performed. The pressing process was carried out at 25° C. using a pressing roller where a linear pressure of the pressing roller was controlled to 2.3 tons, and a gap between upper and lower rollers was adjusted to zero to maximally press a positive electrode, with the result that a thickness of the pressed positive electrode was minimized to obtain a high mixture density. The positive electrode was manufactured to allow the positive electrode active material thereof disposed on one side of the current collector to have a loading level of 45 mg/cm². Thereafter, the second substrate was recovered.

### Comparative

An aluminum substrate was used as a second substrate. A positive electrode was manufactured in the same method as in Embodiment, with a difference that the second slurry was coated on an aluminum substrate and dried to manufacture a second electrode plate.

### Evaluation: Image

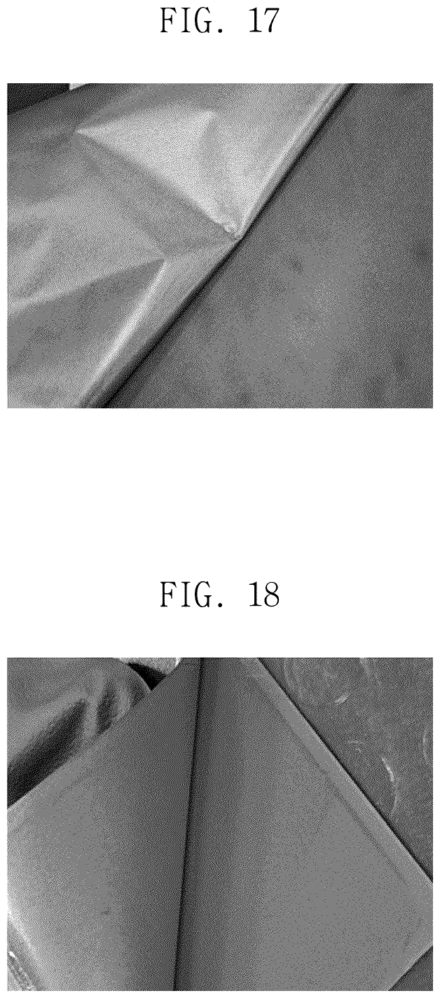

FIG. 17 illustrates an image capturing Comparative. FIG. 18 illustrates an image capturing Embodiment. Referring to FIG. 17, it may be ascertained that an aluminum residue remained on the second electrode plate. In contrast, referring to FIG. 18, it may be ascertained that no residue remained on the second substrate.

In a method of manufacturing a positive electrode according to some example embodiments of the present disclosure, a first positive electrode active material layer may be formed on a first substrate, and a second positive electrode active material layer may be formed on a second substrate which elongation is less than the elongation of the first substrate. As the elongation of the second substrate is less than the elongation of the first substrate, the second substrate may be readily detached from the second positive electrode active material layer. Therefore, it may be possible to readily form thick layers, to reduce or prevent failure occurring when thick layers are formed, and to improve quality of thick layers.

Although some example embodiments of the present disclosure have been discussed with reference to accompanying figures, it is understood that various changes in form and details may be made therein without departing from the spirit and scope of the present disclosure. It is apparent to those skilled in the art that various substitution, modifications, and changes may be thereto without departing from the scope and spirit of the present disclosure.

What is claimed is

1. A method of manufacturing a positive electrode, the method comprising:
manufacturing a first electrode plate by forming a first positive electrode active material layer on a first substrate;
manufacturing a second electrode plate by forming a second positive electrode active material layer on a second substrate;
stacking the second electrode plate on the first electrode plate to allow the second positive electrode active material layer to face the first positive electrode active material layer;
laminating the first electrode plate and the second electrode plate; and
recovering the second substrate,
wherein a first elongation of the first substrate is greater than a second elongation of the second substrate.

2. The method of claim 1, wherein manufacturing the first electrode plate comprises:
preparing a first slurry that comprises a first positive electrode active material, a first solid electrolyte, a first binder, and a first conductive material; and
forming the first positive electrode active material layer by coating the first slurry on the first substrate that moves along a first direction.

3. The method of claim 2, wherein manufacturing the second electrode plate comprises:
preparing a second slurry that comprises a second positive electrode active material, a second solid electrolyte, a second binder, and a second conductive material; and
forming the second positive electrode active material layer by coating the second slurry on the second substrate that moves along the first direction.

4. The method of claim 1, wherein the first elongation is in a range of about 1.14 times to about 8.3 times the second elongation.

5. The method of claim 1, wherein:
the first elongation is in a range of about 8% to about 10%, and
the second elongation is in a range of about 1.2% to about 7%.

6. The method of claim 1, wherein the first substrate comprises one or more of indium (In), aluminum (Al), lithium (Li), and an alloy thereof.

7. The method of claim 1, wherein the second substrate comprises one or more of copper (Cu), magnesium (Mg), titanium (Ti), iron (Fe), cobalt (Co), nickel (Ni), zinc (Zn), stainless steel, germanium (Ge), and an alloy thereof.

8. The method of claim 1, wherein the laminating the first electrode plate and the second electrode plate is performed by a roll press.

9. The method of claim 3, wherein an amount of the first positive electrode active material in the first positive electrode active material layer is in a range of about 80 wt % to about 95 wt %.

10. The method of claim 3, wherein a width in a second direction of the first electrode plate is substantially the same as a width in the second direction of the second electrode plate,
wherein the second direction intersects the first direction.

11. The method of claim 3, wherein at least one of the first and second positive electrode active materials comprises one or more of lithium cobalt oxide (LCO), lithium nickel oxide, lithium nickel cobalt oxide, lithium nickel cobalt aluminum oxide (NCA), lithium nickel cobalt manganese oxide (NCM), lithium manganate, and lithium iron phosphate.

12. The method of claim 3, wherein an amount of the first solid electrolyte in the first positive electrode active material layer is greater than an amount of the second solid electrolyte in the second positive electrode active material layer.

13. The method of claim 3, wherein an amount of the second binder in the second positive electrode active material layer is greater than an amount of the first binder in the first positive electrode active material layer.

14. The method of claim 1, wherein a total loading level of the first and second positive electrode active materials of the first and second positive electrode active material layers located on one side of the first substrate is in a range of about 30 mg/cm² to about 50 mg/cm^{2.}

15. A method of manufacturing a positive electrode, the method comprising:
preparing a first slurry that comprises a first positive electrode active material, a first solid electrolyte, a first conductive material, and a first binder;
preparing a second slurry that comprises a second positive electrode active material, a second solid electrolyte, a second conductive material, and a second binder;
coating on a first substrate the first slurry to form a first positive electrode active material layer;
coating on a second substrate the second slurry to form a second positive electrode active material layer;
stacking the second positive electrode active material layer on the first positive electrode active material layer, the second positive electrode active material layer being on the second substrate;
laminating the first positive electrode active material layer and the second positive electrode active material layer; and
recovering the second substrate,
wherein a first elongation of the first substrate is greater than a second elongation of the second substrate.

16. The method of claim 15, wherein a ratio of the first elongation to the second elongation is in a range of about 1.14:1 to about 8.3:1.

17. The method of claim 15, wherein:
the first elongation is in a range of about 7.5% to about 10%, and
the second elongation is in a range of about 1.2% to about 7%.

18. The method of claim 15, wherein the first substrate comprises one or more of indium (In), aluminum (Al), lithium (Li), and an alloy thereof.

19. The method of claim 15, wherein the second substrate comprises one or more of copper (Cu), magnesium (Mg), titanium (Ti), iron (Fe), cobalt (Co), nickel (Ni), zinc (Zn), stainless steel, germanium (Ge), and an alloy thereof.

20. The method of claim 15, wherein a total loading level of the first and second positive electrode active materials of the first and second positive electrode active material layers located on one side of the first substrate is in a range of about 30 mg/cm² to about 50 mg/cm².
